(19) United States
(12) Patent Application Publication
(10) Pub. No.: US 2005/0071139 A1
(43) Pub. Date: Mar. 31, 2005

(54) Method and system for water flow analysis

(76) Inventors: Avinash S. Patwardhan, West Palm Beach, FL (US); Patrick M. Graham, Vancouver (CA); Jared N. Thorpe, Gainesville, FL (US); Daniel E. Medina, Takoma Park, MD (US)

Correspondence Address: PERKINS COIE LLP;PATENT-SEA, P.O. BOX 1247, SEATTLE, WA, 98111-1247, US

(21) Appl. No.: 10/675,911

(22) Filed: Sep. 29, 2003

(51) Int. Cl. G06G 7/48

(52) U.S. Cl. 703/9

(57) ABSTRACT

A method and system for modeling water flow of a watershed restoration project. The modeling system allows a user to create a graphical representation of the different areas of a development site design. The graphical representation shows the water flows between the different areas. The user may also specify the attributes of each area, such as rate of infiltration, runoff coefficient, size, rate of evapotranspiration, and so on. The modeling system can simulate the impact of rainfall on the development design. The simulation determines the inflow of water to each area and determines the outflow of water for each area. The results of this simulation can be used to evaluate the development design and adjust the design to achieve the desired cost-benefit balance of the watershed protection criteria of choice.

### TECHNICAL FIELD

The described technology relates to analysis of stormwater management control at a development site or at different scales within a watershed.

### BACKGROUND

Land development generally alters the natural water balance of a site. When natural vegetation and soils are replaced with roads and buildings, less rainfall infiltrates into the ground, less rainfall gets taken up by vegetation, and more rainfall becomes surface runoff.

To minimize flooding at a site, traditional ditch and pipe systems have been designed to remove stormwater runoff from impervious surfaces as quickly as possible, and deliver it to receiving waters. As a result, stormwater runoff arrives at the receiving waters much faster and in greater volume than under natural conditions. This speed and volume causes channel erosion, flooding, loss of aquatic habitat, and water quality degradation. If these impacts are not avoided, there can be environmental, legal, financial, and political implications, and so on.

“Stormwater source control” is used to capture rainfall at the source (e.g., on building lots or within road right-of-ways) and return it to natural hydrologic pathways—infiltration and evapotranspiration—or reuse it at the source. Stormwater source control creates hydraulic disconnects between impervious surfaces and watercourses (e.g., streams), thus reducing the volume and rate of surface runoff.

It is currently difficult to assess the cost and benefit tradeoffs of stormwater source controls. Watersheds typically have a management plan developed based on a watershed study that provides a realistic and feasible framework for overall watershed protection that includes combining watershed controls like best management practices and land use management. Because these studies, however, are conducted at a large scale, the effects of individual stormwater management source control measures cannot be effectively evaluated. Without knowing the effects of these measures, it is difficult to strike a balance between watershed protection, economic growth, and quality of life issues.

It would be desirable to have an effective way to analyze the effects of various stormwater source control efforts on a development.

### BRIEF DESCRIPTION OF THE DRAWINGS

FIG. 1 is a display page illustrating a high-level development design in one embodiment.

FIG. 2 is a block diagram illustrating components of the modeling system in a one embodiment.

FIG. 3 illustrates dialog boxes for specifying the environmental conditions of the development.

FIG. 4 illustrates a dialog box for specifying the soil types of the development.

FIG. 5 illustrates a dialog box summarizing the composition of the areas of the development.

FIG. 6 illustrates icons representing different land uses that can be part of a development.

FIG. 7 illustrates an example of a detailed design of a new residential development in one embodiment.

FIG. 8 is a dialog box illustrating attributes of a development design in one embodiment.

FIG. 9 illustrates the dialog box for the rainfall of an area.

FIG. 10 illustrates the dialog box for evapotranspiration of an area.

FIG. 11 illustrates the dialog box for the attributes of an impervious area.

FIG. 12 illustrates the dialog boxes for an overland flow plane.

FIGS. 13a-13c illustrate the dialog boxes for soil infiltration.

FIGS. 14a-14d illustrate the dialog boxes for media infiltration.

FIG. 15 illustrates a dialog box for the soil type.

FIG. 16 illustrates a display page for the setting of watershed protection criteria in one embodiment.

FIG. 17 illustrates peak flow criteria information.

FIG. 18 illustrates flow volume of criteria information.

FIGS. 19a-19c are dialog boxes for the optimization process.

FIG. 20 is a flow diagram of the create design component in one embodiment.

FIG. 21 is a flow diagram illustrating the simulate component in one embodiment.

FIG. 22 is a flow diagram illustrating the optimizers component in one embodiment.

FIG. 23 is a flow diagram illustrating the calculations performed by a rainfall object.

FIG. 24 is a flow diagram illustrating the calculations performed by an impervious object, such as a roof object.

FIG. 25 is a flow diagram illustrating the calculations performed by a routing object, such as a channel.

FIG. 26 is a flow diagram illustrating the calculations performed by the flow balance component of the routing object in one embodiment.

FIG. 27 is a flow diagram illustrating the processing of the calculations performed by the soil infiltration component in one embodiment.

FIG. 28 is a flow diagram illustrating processing of the calculations performed by the water balance component of the soil infiltration object in one embodiment.

### DETAILED DESCRIPTION

A method and system for modeling water flow (e.g., stormwater, point sources, and water withdrawals) of a watershed restoration project is provided. In one embodiment, the modeling system allows a user to create a graphical representation of the different areas of a development site design. The graphical representation shows the water flows between the different areas. The user may also specify the attributes of each area, such as rate of infiltration, runoff coefficient, size, rate of evapotranspiration, and so on. The modeling system can simulate the impact of rainfall on the development design. The rainfall may be specified on a user-defined time step (e.g., hourly) over a certain period (e.g., one month). The simulation determines the inflow of water to each area and determines the outflow of water for each area. The inflow may be from rainfall, runoff from another area, etc.; and the outflow may be from runoff, infiltration, evapotranspiration, groundwater losses, etc. The results of this simulation can be used to evaluate the development design and adjust the design to achieve the desired cost-benefit balance of the watershed protection criteria of choice (e.g., peak water flow). The modeling system may allow a user to specify various watershed protection criteria, which can include peak water flow, flow volume, and water quality, and so on. The modeling system evaluates, based on the simulation, whether any criterion is exceeded. The modeling system can be used to model various types of water flows including stormwater runoff and combined stormwater and sewer flows.

In one embodiment, the modeling system provides objects representing the possible types of areas within each land use that can be part of a development. The land uses may include residential, commercial, industrial, and so on. Each land parcel of the development has an associated land use and is divided into areas that can be pervious and impervious. The impervious areas include roofs, driveways, and roads; and pervious areas include open spaces and yards. The modeling system may provide objects for roofs, driveways, roads, open spaces, and yards. The modeling system also provides objects for sources and sinks of water. The sources of water may include rainfall, a river, reuse, etc., and the sinks of water may include evapotranspiration, soil infiltration, etc. Each object provides a model of its type of area. For example, the object for a roof may model the amount of runoff based on the size of the roof, the amount of rainfall, and a runoff coefficient.

The modeling system allows a user to prepare a graphical representation of the areas of the development showing the dependencies (i.e., water outflows and water inflows) between the areas. Each area of the development may be graphically represented by an icon. Each lot of a residential development may be represented by a roof area, a driveway area, a yard area, and a road area and thus be represented by multiple icons. The roof, driveway, and road areas may have a rainfall inflow and runoff outflow, whereas the yard area also has a rainfall inflow and runoff outflow, and additionally has a soil infiltration, water flow, groundwater, etc., outflow. If the runoff outflow of a lot is directed to an open space, then a dependency between the runoff outflow of the lot and the inflow of the open space is established, which may be represented by a line connecting an icon of the lot and the open space. A dependency indicates that water flows from one area to another area.

The modeling system allows the user to specify attributes of the areas and sources of water of the development. The attributes of an open-space area may include its size, slope, soil type, and so on. The attributes of a rainfall water source may be the hourly rainfall totals over a certain period, such as the three months of a rainy season. The modeling system simulates the water flows by iteratively calculating the outflows and inflows of each area of the development at certain intervals. For example, if the rainfall totals are hourly, then the modeling system may perform the calculations representing one-hour intervals. The modeling system calculates the total water inflow for each area based on the rainfall amounts and the total water outflow of each area based on runoff coefficients, infiltration rates, and so on. The dependencies define the order in which the calculations for each object are performed. In particular, the calculations for an area are not performed until the calculations for the areas that provide it water are first calculated. The modeling system can track and provide reports based on peak water flows and total water flow for each area within the development. The modeling system allows the user to change the attributes and areas of the development to analyze the effects of different land uses on the watershed.

In one embodiment, the modeling system may provide an interface to a geographic information system (“GIS”) to input information relating to the development site to be modeled. The modeling system may allow a user to select the developments, lots, etc. of the GIS whose information is to be used by the modeling system. For example, if a new development is selected, then the number of lots and attributes (e.g., size) of the areas of each lot can be retrieved from the GIS and used to initialize the data of the modeling system. The modeling system allows the user to modify these attributes and specify the inter-area water flows.

In one embodiment, the modeling system provides an optimizer that identifies a development design that is optimal as indicated by an objective function. After a user defines a development design, the user specifies an objective function that rates the design. The objective function may, for example, define profit for the development and thus rate the design based on amount of profit. The user also defines various constraints of the development design. For example, one constraint may be the minimum and maximum number of lots in a residential development, and another constraint may be the minimum and maximum number of acres of open space. The modeling system selects initial parameters (e.g., 150 lots) within the constraints, performs the simulation with those parameters, and then calculates the objective function. The system then selects new parameters, performs the simulation, and re-calculates the objective function. The modeling system selects the new parameters based on whether the objective function is converging to an optimal solution. One skilled in the art will appreciate that various well-known optimization techniques may be used for guiding the selection of parameters. The system repeats this process until the parameters for the highest rated optimized design is found.

In one embodiment, the modeling system provides a continuous-simulation, model based largely on physical processes that occur within bio-retention facilities, vegetated swales, green roofs, and infiltration devices, as well as effects of site fingerprinting and soil compaction. The modeling system accounts for runoff generation from all categories of land covering including roadways, landscaping, and buildings over a variety of land uses and soil types, for new development and redevelopment.

The modeling system optimizes the balance between economic growth and watershed protection. The modeling system provides least-cost stormwater management solutions that meet watershed protection and quality-of-life objectives. Some of the potential uses of the model are to identify appropriate, site-specific best management practices, and to evaluate the effects of volume-based, peak flow, and water quality controls. The modeling system, developed on an Extend dynamic stimulation platform in one embodiment, is a visually oriented interactive tool that allows a wide range of applications from site design, site analysis and review, and public education.

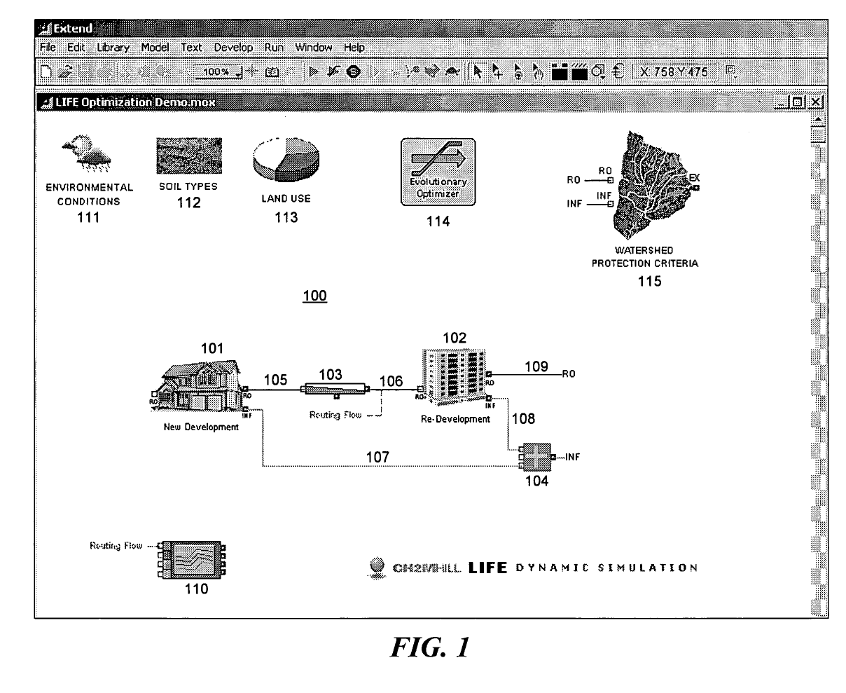

FIG. 1 is a display page illustrating a high-level development design in one embodiment. One skilled in the art will appreciate that the modeling system can be used to model flow of water for any development design with different areas and inter-area flow of water and with or without various best management practices. The development design 100 includes a new development icon 101 and a redevelopment icon 102. The new development icon represents a new residential development that may include many lots and open spaces. The redevelopment icon represents a commercial redevelopment. The lines between the icons represent flow of water and thus dependencies. For example, line 105 between the new development icon 101 and the routing flow icon 103 represents the runoff flowing from the new development to a channel or overland flow plane. Similarly, line 106 between the redevelopment icon 102 and the routing flow icon 103 represents the runoff flowing from the redevelopment to the channel or overland flow plane. The aggregation icon 104 represents combining the soil infiltration of the new development represented by line 107 and the soil infiltration of the redevelopment represented by line 108 resulting in the aggregate infiltration for the development design. Line 109 represents the runoff from the redevelopment that is not routed. Icon 110 represents various graphs of the simulated water flow. Icons 111, 112, and 113 allow a user to specify and view various attributes of the development design. For example, the environmental conditions icon 111 is used to set the rainfall and evapotranspiration attributes. The soil types icon 112 is used to specify the types of soil found in the development. The land use icon 113 is used to summarize the various land uses within the development (e.g., total impervious acres for each land use). The evolutionary optimizer icon 114 is used to specify constraints and the objective function for the optimization process. The watershed protection criteria 115 is used to establish various levels for watershed protection such as peak flow, flow volume, or water quality. The user specifies the level or combinations of levels, and the modeling system highlights any excedences based on the simulation results.

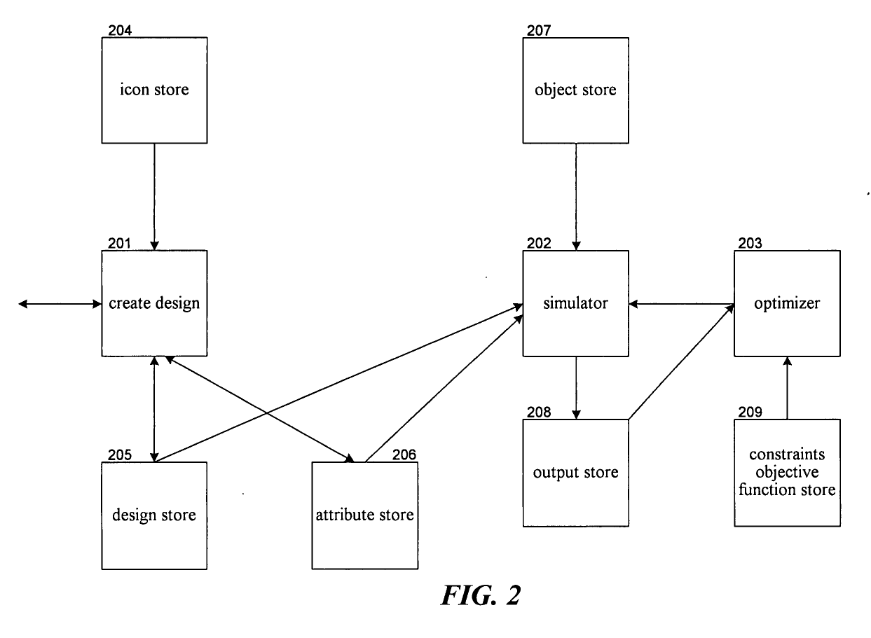

FIG. 2 is a block diagram illustrating components of the modeling system in one embodiment. The modeling system comprises a create design component 201, a simulate component 202, and an optimize component 203. The create design component is used to generate a development design. The create design component receives user input on the placement of icons representing the development design. The user selects from the icons of the icon store 204. The create design component stores the design in the design store 201 and the user-specified attribute in the attributes store 206. The create design component handles the interaction with the user to place icons, connect icons, and set the values for the various attributes. The create design component may also import areas of the development and their attributes from a GIS. The simulate component simulates the flow of water based on the development design as indicated by the design store and the attribute store. The simulator component instantiates an object from object store 207 for each icon represented in the design store. In one embodiment, an object is defined for each type of icon. For example, each type of area has an object that is invoked by the simulate component to calculate the outflow of an area including evaporation, transpiration, and infiltration during each iteration of the simulation. The simulate component may invoke other objects to initialize or input values before the simulation. The simulate component invokes the objects representing an area during each iteration of the simulation in an order based on the dependencies. The results of the simulation are stored in output store 208. The output may include a history of the flow information of each object for each iteration. The optimize component identifies a set of parameters for the development design that best fits an objective function. The objective function and constraints for the optimization are stored in the constraint and objective function store 209. The optimize component sets initial parameters for the simulation within the constraints and then performs the simulation. The optimize component then evaluates the objective function and selects a new set of parameters within the constraints. The optimize component repeats the performing of the simulation and establishing of new parameters repeatedly until the evaluation of the objective function converges to an optimal solution (e.g., maximize profits).

The modeling system may execute on a computer system that includes a central processing unit, memory, input devices (e.g., keyboard and pointing devices), output devices (e.g., display devices), and storage devices (e.g., disk drives). The memory and storage devices are computer-readable media that may contain instructions that implement the modeling system. In addition, the data structures and message structures may be stored or transmitted via a data transmission medium, such as a signal on a communications link. The modeling system may be implemented using various well-known simulator tools. In one embodiment, the modeling system is implemented on the Extend modeling environment, which is described in detail in “The Extend Simulation Environment” by David Krahl, published in the Proceedings of the 2000 Winter Simulation Conference, which is hereby incorporated by reference.

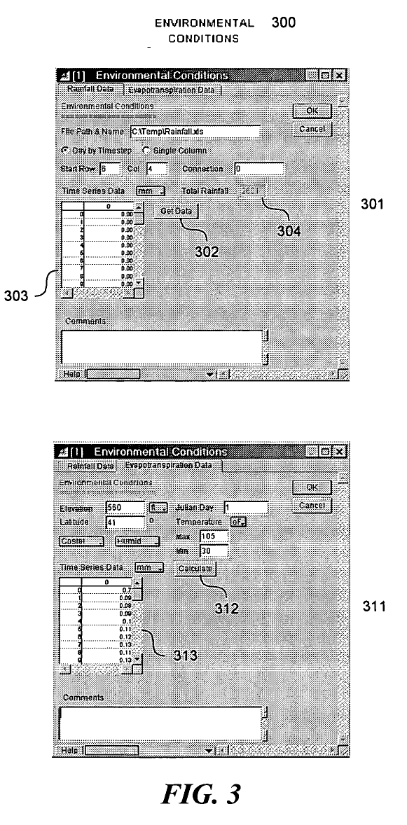

FIG. 3 illustrates dialog boxes for specifying the environmental conditions of the development. When a user selects icon 300, the modeling system displays dialog boxes 301 and 311. The rainfall dialog box 301 is used to specify the rainfall amounts for the development. The rainfall amounts may be imported from a spreadsheet that specifies the rainfall amount per period (e.g., hour). The dialog box is used to specify the location and format of the spreadsheet. The get data button 302 is used to retrieve the rainfall data, which is displayed in field 303 and totaled in field 304. In one embodiment, the rainfall amounts are assumed to be same throughout the development. One skilled in the art will appreciate that different rainfall amounts could be specified for different parts of the development. For example, a residential development on a dry side of a mountain may have a rainfall amount that is different from a residential development on the other side of the mountain indicating a choice of multiple rainfall stations within a development- or watershed. The evapotranspiration dialog box 311 specifies attributes of the amount of water that leaves the watershed per certain area because of evaporation or transpiration. The dialog box is used to specify evapotranspiration parameters, elevation, latitude, minimum and maximum temperatures, and characteristics of the location such as coastal or humid. The calculate button 312 is used to calculate the evapotranspiration amounts based on these parameters (e.g., using the Penman-Monteith equation) and display the amounts in field 313.

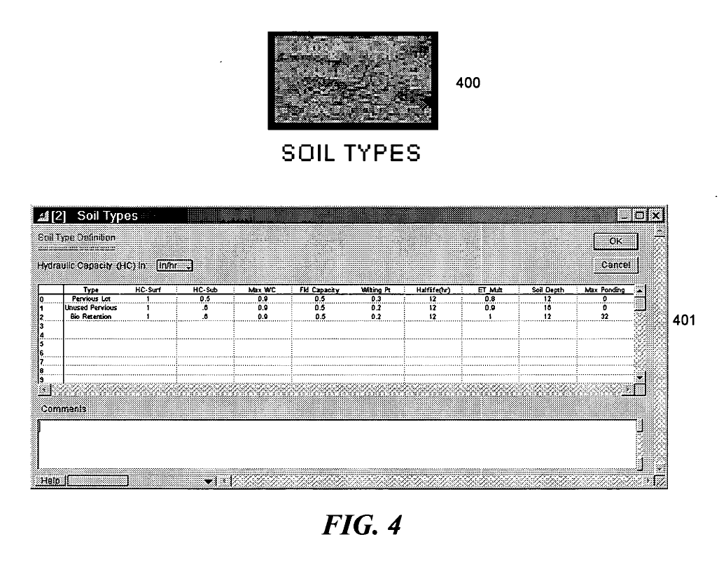

FIG. 4 illustrates a dialog box for specifying the soil types of the development. When the user selects icon 400, the modeling system displays dialog box 401. The soil types dialog box 401 indicates that three types of soil for an example development have been specified: pervious lot, unused pervious, and bioretention. One skilled in the art will appreciate that any number of soil types can be simulated by the modeling system. The attributes of each type of soil include hydraulic capacity of the surface and subsurface, maximum water content, flood capacity, wilting point, water half-life, evapotranspiration multiplier, soil depth, and maximum ponding. Each pervious area of the development design is designated as having one of these soil types.

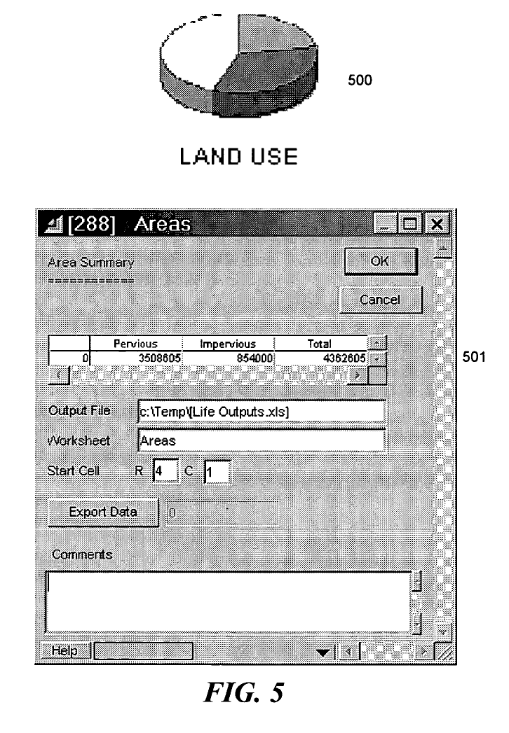

FIG. 5 illustrates a dialog box summarizing the composition of the areas of the development. When a user selects land use icon 500, the modeling system displays dialog box 501. The areas dialog box 501 indicates the pervious and impervious size of each land use within the development. In this example, land use 0 has a pervious area of about 3.5 million square feet, an impervious area of 850,000 square feet, and a total area of 4.36 million square feet.

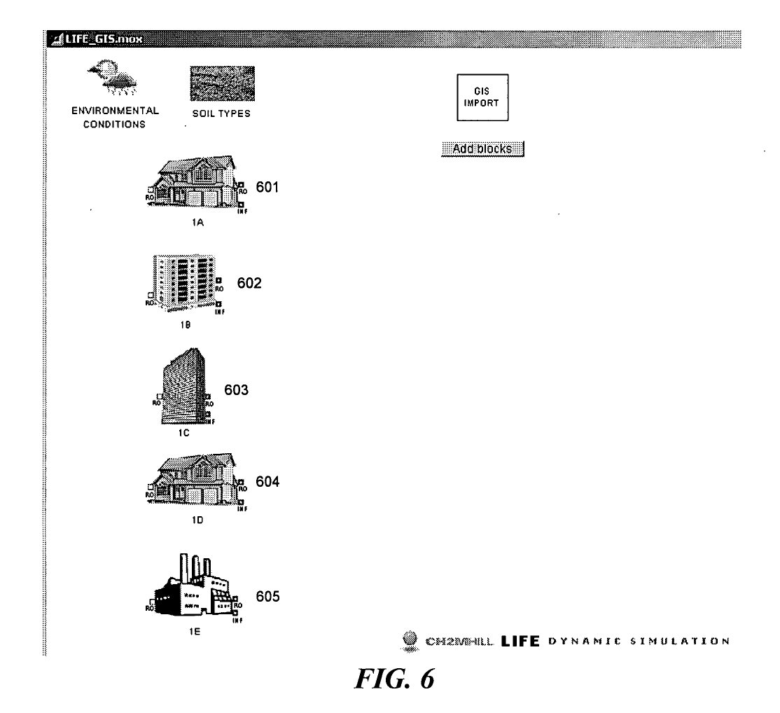

FIG. 6 illustrates icons representing different land uses that can be part of a development. In this example, the icons represent the different land uses imported from a GIS. Icon 601 represents a new residential development, icon 602 represents a commercial redevelopment, icon 603 represents a commercial development, icon 604 represents a residential redevelopment, and icon 605 represents a factory. To create a development design, a user selects land use icons and positions them on the display. The user can then specify the dependencies between them. This specifies the high-level development design. To specify the details of each land use, the user selects the land use and is provided with a blank display page area. The user then positions on the display page the areas that comprise the land use. For example, the user may position an icons for a roof, driveway, and yard to represent a lot. Alternatively, the details can be imported from the GIS. The user can then specify the dependencies of the design. To specify a dependency, the user may select an outflow of one icon and connect it to an inflow of another icon. The modeling system then draws a line between the icons. The modeling system provides a hierarchy of land uses and areas within a land use. One skilled in the art would appreciate that a development design may specify many different levels within the hierarchy. For example, a development design may include a new residential development and a commercial redevelopment at its highest level. The next level of the residential development may specify lots, open spaces, and bioretention facilities. The next level of the lots may specify various areas of the lot, such as roof, driveway, road, and yard.

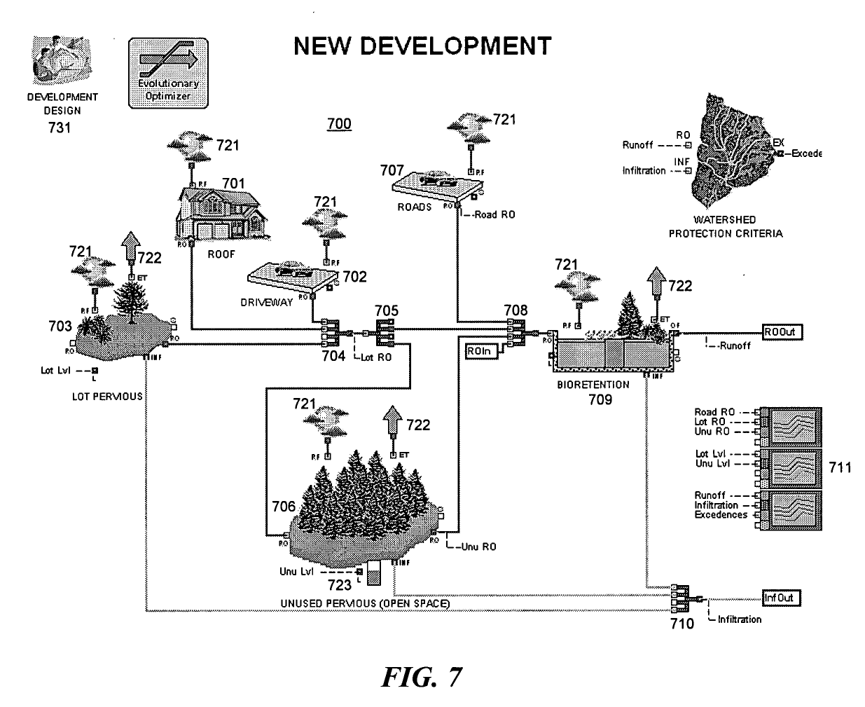

FIG. 7 illustrates an example of a detailed design of a new residential development in one embodiment. This new development 700 corresponds to new development 101 of FIG. 1. The new development is represented by icons 701-710. Roof icon 701, driveway icon 702, yard icon 703, and road icon 707 represent the areas (e.g., on average) of each residential lot. The development design icon 731 is used to specify the attributes of the residential lots. For example, the development design may specify that there are 100 lots with the certain average roof size, driveway size, yard size, and road size contribution. Icons 721 represent the total rainfall for each area. The user can select a rainfall icon 721 to view information about the rainfall for the area. Evapotranspiration icons 722 may be selected by the user to view the evapotranspiration characteristics of an area. Infiltration icon 723 may be selected by the user to view the infiltration rate of an area. The aggregating icons 704, 708, and 710 specify that outflows from various areas are to be aggregated. For example, aggregating icon to 710 indicates that the infiltration for areas 703, 706, and 709 are to be aggregated into a total infiltration for the new development. The splitting icon 705 indicates that a flow is to be divided into multiple flows. A splitting flow may have percentages associated with each outflow to indicate the percentage of inflow that is to be provided to that outflow. The open space icon 706 represents a pervious open space of the development. The bioretention icon 709 represents a bioretention facility within the development. One skilled in the art will appreciate that various best management practices can be used for stormwater control such as bioretention, detention basins, two-layer infiltration and so on. The bioretention facility has associated rainfall, evapotranspiration, and infiltration characteristics. The lines connecting the icons represent the various water flows within the development and thus dependencies. For example, the bioretention facility receives runoff from the lot and the open space. Thus, the bioretention facility is dependent on all the other areas within the development. The open space area is, however, only dependent on the roof, driveway, and yard areas of a lot because the runoff from the roads are routed to directly to the bioretention facility and not to the open space. Thus, when the modeling system performs the simulation of the water flow for this example, the calculations for the roof, driveway, and yard areas are performed before the calculations for the open space, and the calculations for the open space are performed before the calculations for the bioretention facility. In one embodiment, the modeling system may animate the development design during the simulation. For example, if there is rainfall during an iteration, then the rainfall icons may be switched to show rain. As another example, the color of the lines between the icons may be changed to red when capacities are exceeded.

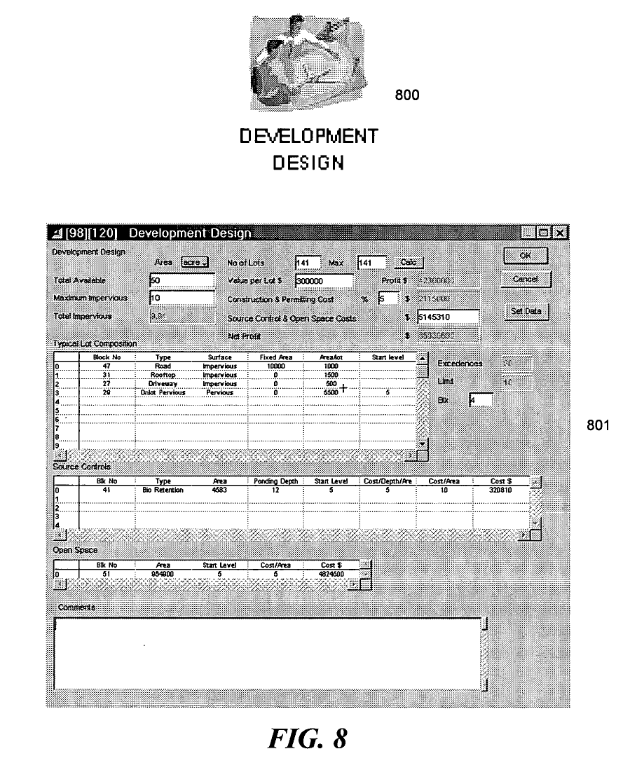

FIG. 8 is a dialog box illustrating attributes of a development design in one embodiment. When a user selects icon 800, the modeling system displays dialog box 801. The development design dialog box 801 indicates that the attributes include the number of lots in the development, the size of the development (e.g., in acres), the monetary value of each lot, the construction and permitting costs as a percent of lot value, the total source control and open-space costs, the typical composition of each lot, and the types of source controls and bioretention facilities. The modeling system calculates the profit, construction and permitting cost per lot, and net profit based on the cost and the design of the development. In this example, each lot is allocated a road area, a roof area, a driveway area, and an on lot pervious (or yard) area. Each area may be assigned a fixed area size plus an area size per lot. For example, the total roads may have a fixed area of 10,000 square feet and each lot adds an additional 1000 square feet to the total road area. The source control facilities may include a bioretention facility and other best management practices. The bioretention facility may be defined with an area, a ponding depth, a cost per depth per area, a cost per area, and a total fixed cost. The open space area may be defined by an area size, a cost per area, and a total fixed cost.

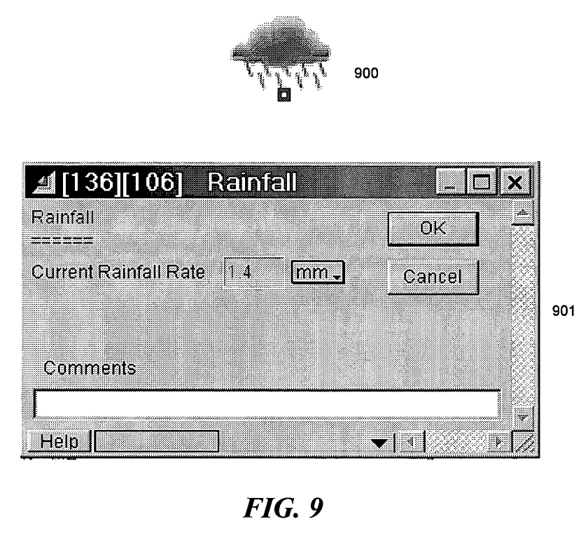

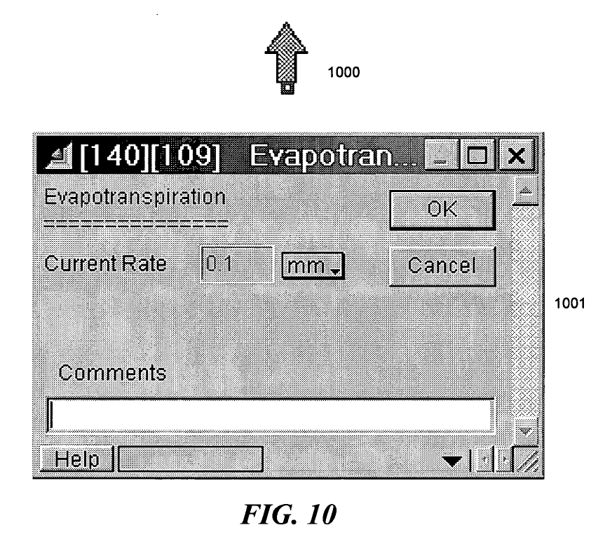

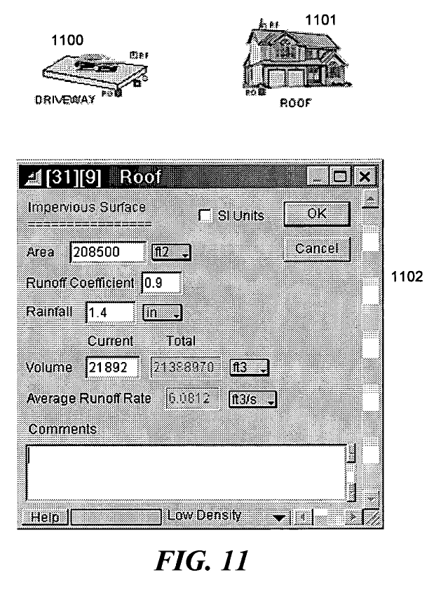

FIGS. 9-15 illustrates dialog boxes displayed when the icons of a development design are selected. FIG. 9 illustrates the dialog box for the rainfall of an area. The rainfall icon 900 represents of the amount of rainfall for the corresponding area. When animated, icon 900 and icon 721 may be used to indicate rainfall or no rainfall during each iteration. When a rainfall icon is selected, the modeling system displays dialog box 901. The dialog box displays the current rainfall rate input from the rainfall station during the last iteration of the simulation. The modeling system updates the current rainfall rate at each iteration and may change the rainfall icon based on whether any rainfall was present for that iteration. FIG. 10 illustrates the dialog box for evapotranspiration of an area. When a user selects the evapotranspiration icon 1000 associated with an area, the modeling system displays a dialog box 1001. The dialog box 1001 displays the current evapotranspiration rate for the area. The modeling system updates in the current evapotranspiration rate at each iteration. FIG. 11 illustrates the dialog box for the attributes of an impervious area. In this example, the impervious areas are represented by a driveway icon 1100 and a roof icon 1101. When a user selects either of these icons, the modeling system displays the dialog box 1102. The dialog box 1102 includes an area field, a runoff coefficient field, a rainfall field, a total and current water volume fields, and an average runoff rate field.

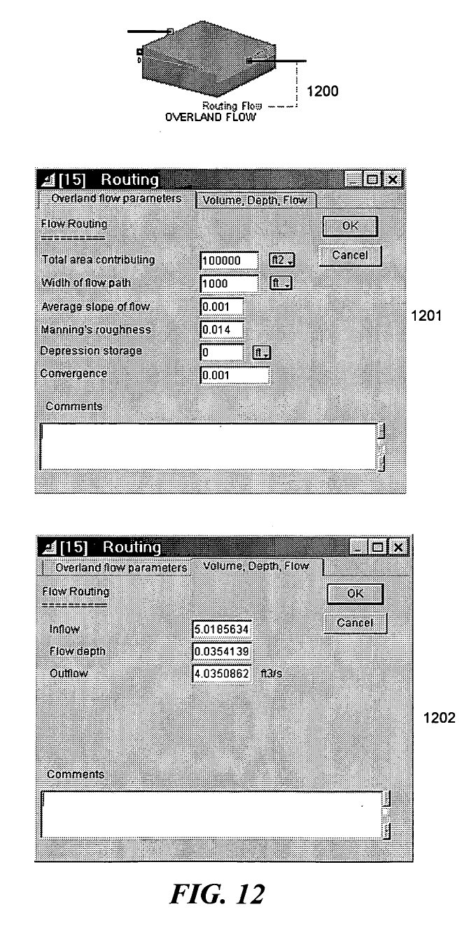

FIG. 12 illustrates the dialog boxes for an overland flow plane. An overland flow plane is represented by icon 1200. When a user selects a water channel icon, the modeling system displays the dialog boxes 1201 and 1202. The dialog box 1201 displays the attributes of the overland flow plane. For example, it includes a total area contributing field, a width of flow path field, an average slope of flow field, a Mannings's roughness field, a depression storage field, and a convergence field. Dialog box 1202 displays the attributes of the volume, depth, and flow on the overland flow plane. The dialog box includes an inflow field, a flow depth field, and an outflow field.

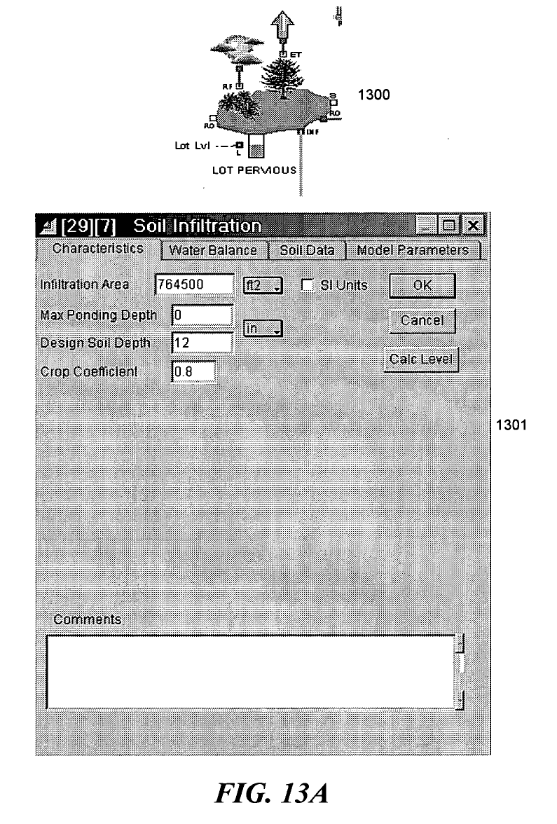

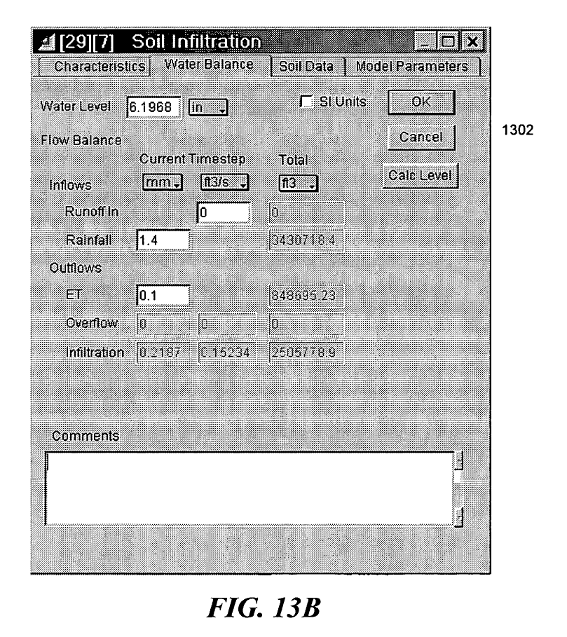

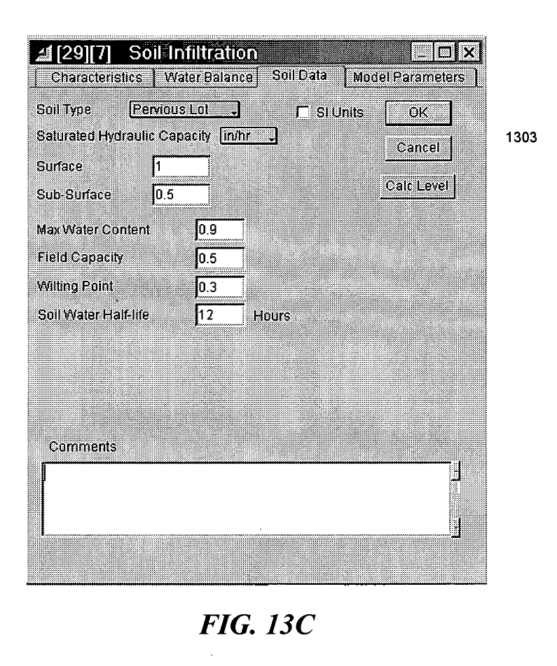

FIGS. 13a-13c illustrate the dialog boxes for soil infiltration process in a soil layer. This process can be used to simulate infiltration on any type of pervious land or in cases where a soil medium is used. In this example, when a user selects the soil infiltration icon 1300, the modeling system displays dialog boxes 1301-1303. Dialog box 1301 has fields identifying the characteristics of soil infiltration that include an infiltration area field, a maximum ponding depth field, a design soil depth field, and a crop coefficient field. Dialog box 1302 contains fields representing the water balance in the soil profile. The dialog box includes a water level field, inflow fields for runoff and rainfall, and outflow fields for evapotranspiration, overflow, and infiltration. Dialog box 1303 contains soil data that is used in calculating soil water balance of which infiltration is a part. The dialog box includes a soil type field, saturated hydraulic capacity surface and sub-surface fields, a maximum water content field, a field capacity field, a wilting point field, and a soil water half-life field.

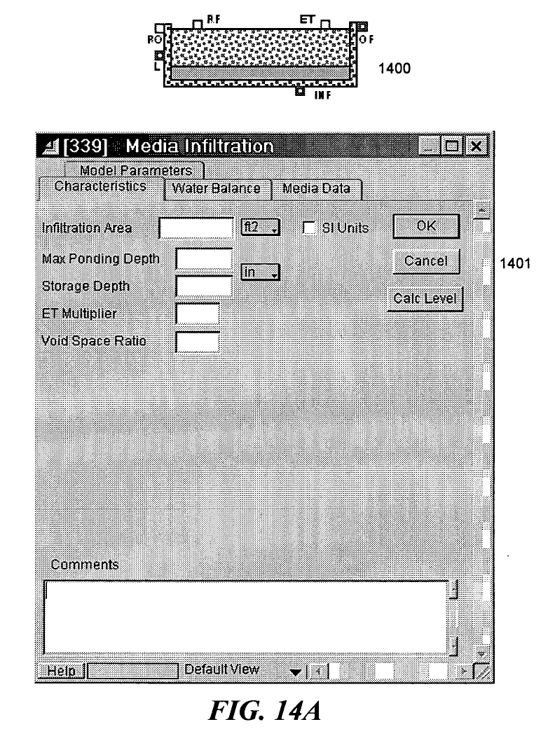

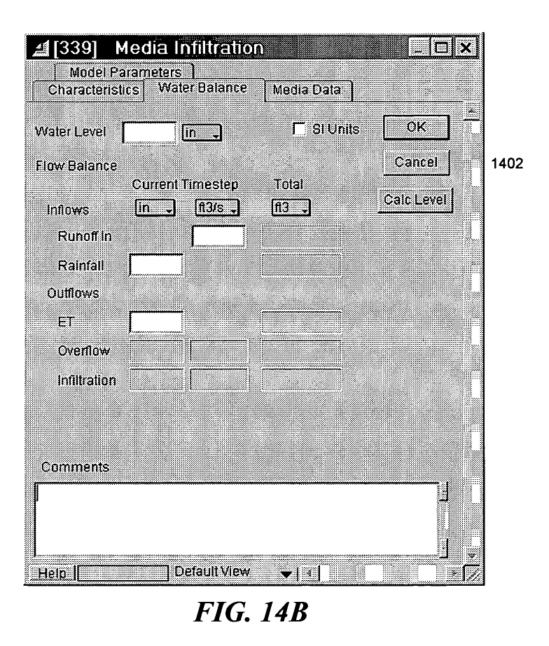

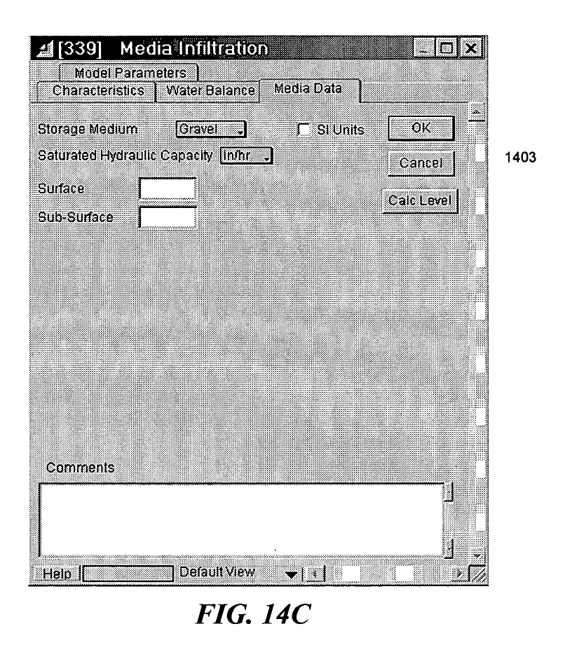

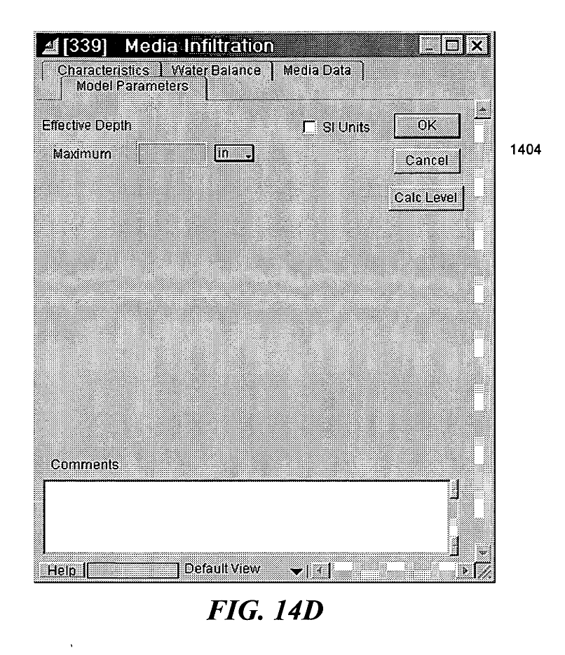

FIGS. 14a-14d illustrate the dialog boxes for media infiltration. When a user selects the media infiltration icon 1400, the modeling system displays the dialog boxes 1401-1404. Dialog box 1401 contains fields for the characteristics of the media infiltration including an infiltration area field, a maximum ponding depth field, a storage depth field, an evapotranspiration multiplier field, and a void space ratio field. Dialog box 1402 includes fields for water balance including a water level field, inflow fields of runoff in and rainfall, and outflow fields of evapotranspiration, overflow, and infiltration. Dialog box 1403 contains fields for media data such as a storage medium field and saturated hydraulic capacity fields of surface and subsurface. Dialog box 1404 contains model parameters such as the maximum effective depth of the media.

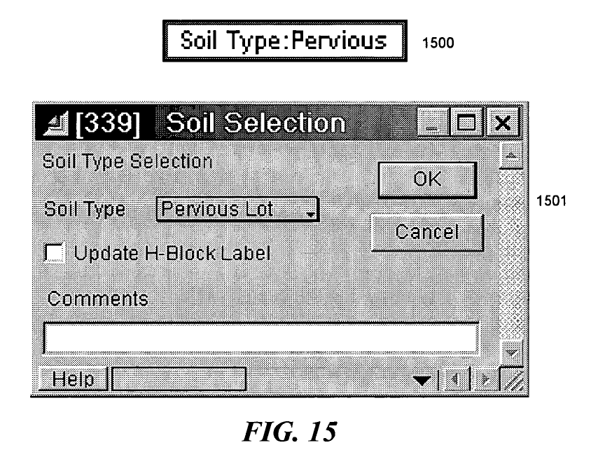

FIG. 15 illustrates a dialog box for soil type. When a user selects a soil type icon 1500, the modeling system displays the dialog box 1501. The dialog box illustrates the soil type of the associated area.

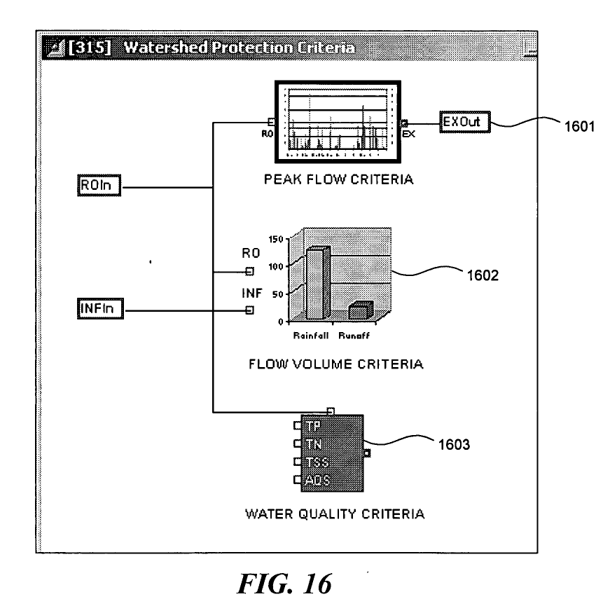

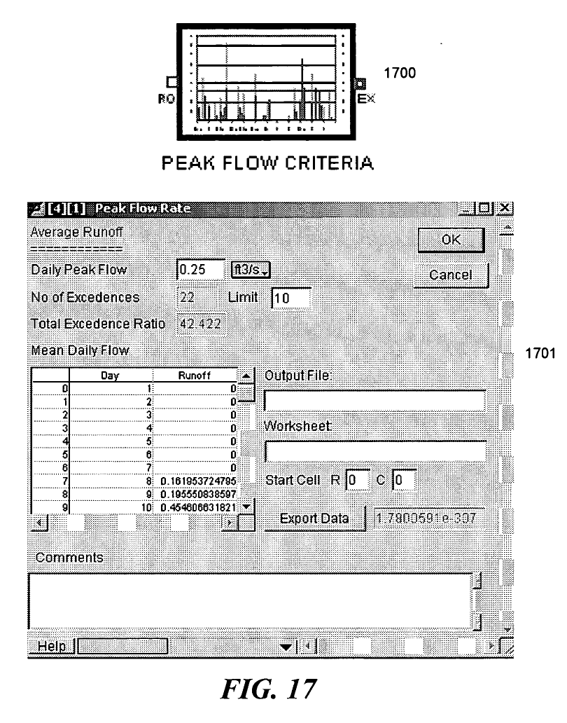

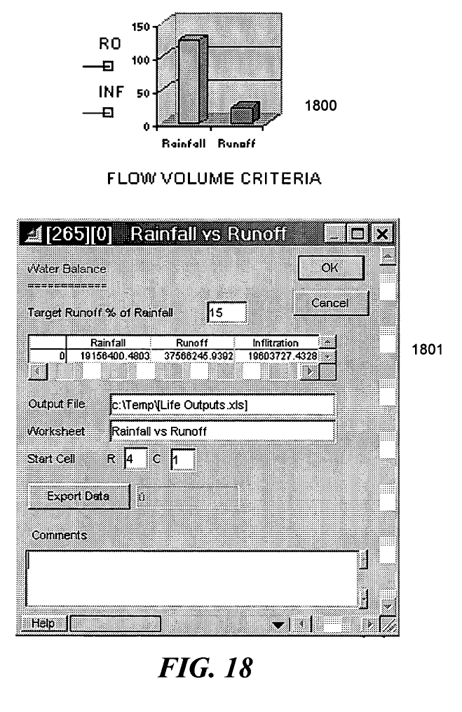

FIG. 16 illustrates a display page for the setting of watershed protection criteria in one embodiment. The modeling system displays this page when a user selects a watershed protection criteria icon, such as icon 115 of FIG. 1. When the user selects icon 1601, the modeling system displays a peak flow criteria dialog box for the development. When the user selects icon 1602, the modeling system displays volume flow criteria dialog box for the development. When the user selects icon 1603, the modeling system displays a water quality criteria dialog box for the development. FIG. 17 illustrates peak flow criteria information. When the user selects icon 1700, the modeling system displays dialog box 1701. The dialog box contains daily peak flow rate information fields including a number of excedences field, a total excedence ratio field, and a mean daily flow field. A user can specify the daily peak flow rate and the limitation on the number of excedences that can be allowed while still meeting the criteria of watershed protection. The dialog box also allows this information to the exported to a spreadsheet. FIG. 18 illustrates flow volume of criteria information. When the user selects icon 1800, the modeling system displays dialog box 1801. The dialog box contains the water balance fields for the development including a target runoff percent of rainfall field that is set by a user, a total rainfall field, a total runoff field, and a total infiltration field. When a user selects the water quality criteria icon 1603, the modeling system displays a dialog box (not shown) that allows the user to specify the limits on total phosphates, total nitrogen, total suspended sediment, aquatic score (e.g., safe for fish), and so on.

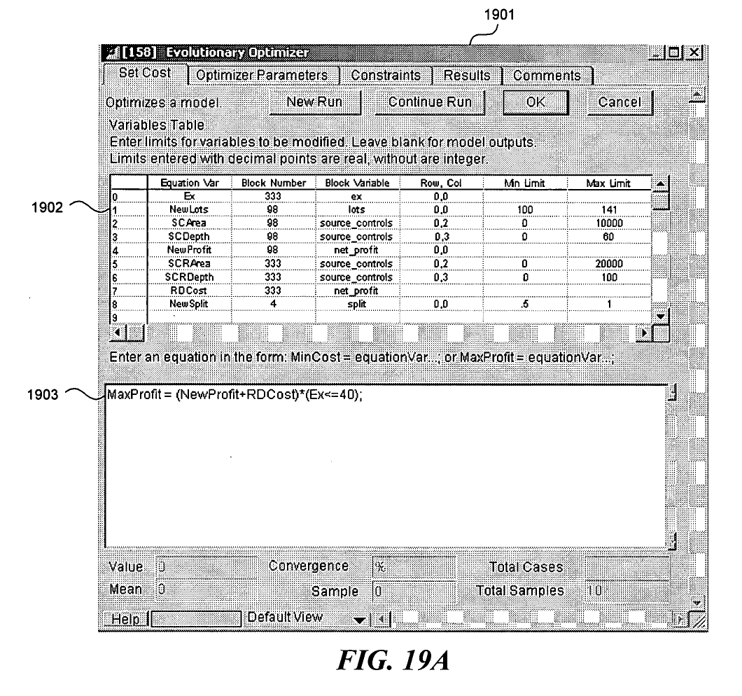

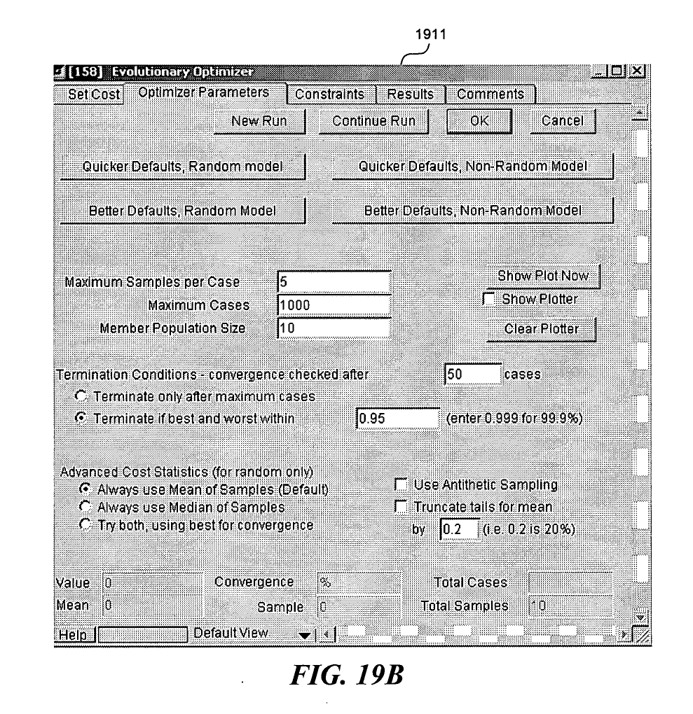

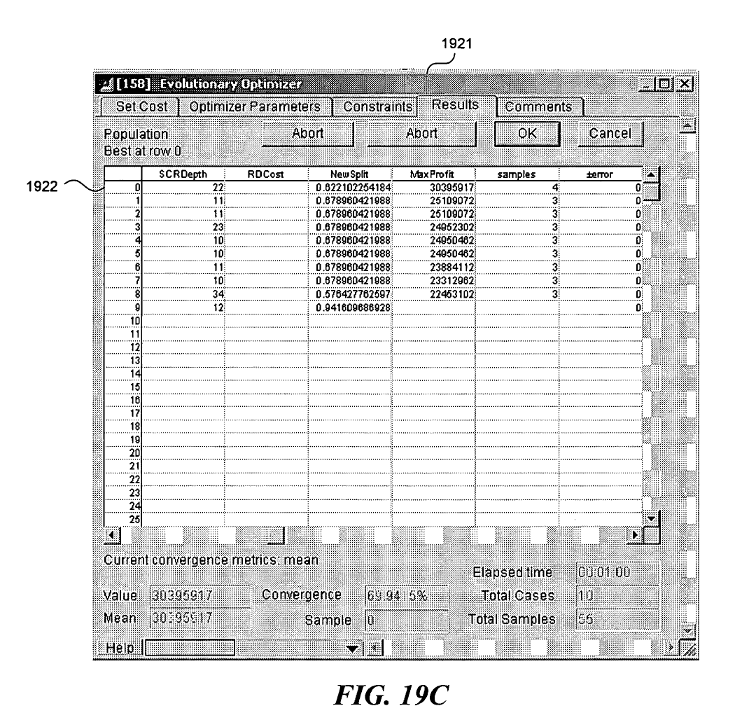

FIGS. 19a-19c are dialog boxes for the optimization process. These dialog boxes are standard dialog boxes provided by an optimization system such as the Extend Evolutionary Optimizer. Dialog box 1901 displays the constraints or limits for the optimization that are used for this example, however, these constraints can be modified depending on the application. For example, row 1902 specifies that the number of lots is constrained to between 100 and 141. Equation 1903 specifies the objective function. In this example, the objection function is the maximum profit. Dialog box 1911 displays various options for controlling the optimization process. Dialog box 1921 displays the maximum profit calculated for each simulation with a different set of parameters. In this example, row 1922 represents the maximum profit. The values of the constrained parameters for each simulation can be viewed by scrolling to the right.

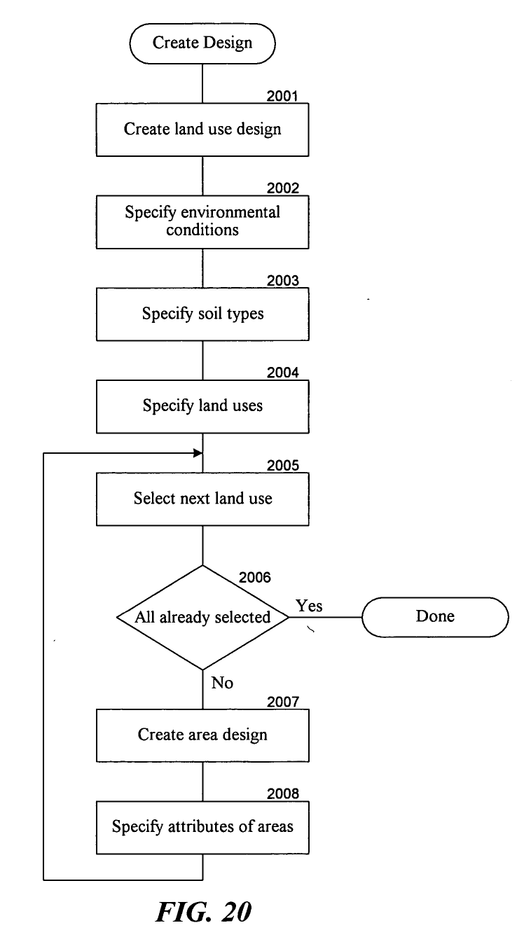

FIGS. 20-28 are flow diagrams illustrating the processing of the modeling system in one embodiment. FIG. 20 is a flow diagram of the create design component in one embodiment. The create design component controls the user interface for creating the graphical representation of the development designs and setting of the attributes of the designs. In block 2001, the component creates a land-use design based on user input. A user may select various land-use icons and place them on the display page and then indicate the dependencies of the land uses. In block 2002, the component allows a user to specify the environmental conditions, such as rainfall and evapotranspiration, for the development. In block 2003, the component allows the user to specify the possible soil types for the development. In block 2004, the component allows the user to specify the attributes of the land uses. In blocks 2005-2008, the component loops selecting each land use and creating a detailed design of the areas within that land use. In block 2005, the component selects the next land use. In decision block 2006, if all the land uses have already been selected, then the component completes, else the component continues at block 2007. In block 2007, the component creates the detailed area design for the selected land use. The component allows a user to place area icons on the display representing the areas of the selected land use. The user interconnects the icons to indicate the dependencies of the water flow. In block 2008, the component specifies the attributes of each area. The component then loops to block 2005 to select the next land use.

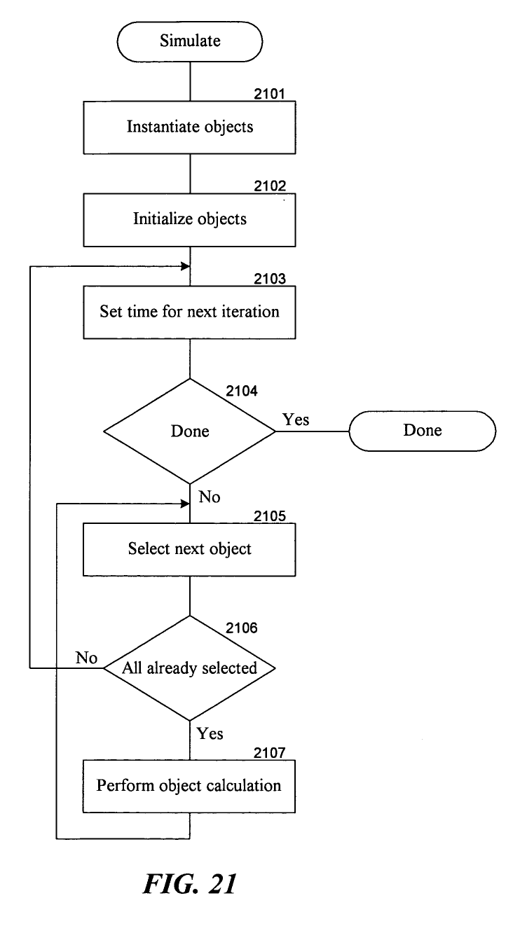

FIG. 21 is a block diagram illustrating the simulate component in one embodiment. The component initializes the objects for the simulation and then iteratively invokes the components for each interval of the iteration period. In block 2101, the component instantiates an object for each icon of the development design. In block 2102, the component initializes each object. The initialization of an object allows for processing that needs to be performed at the start up of the simulation. For example, a rainfall object may load rainfall information and store it in an array in memory. In blocks 2103-2107, the component loops performing each iteration. In block 2103, the component sets the time for the next iteration. In decision block 2104, if the time is passed the end of the simulation, then the component completes, else the component continues at block 2105. In blocks 2105-2107, the component loops performing the calculation for each object in dependency order. In block 2105, the component selects the next object in dependency order. In decision block 2106, if all the objects have already been selected, then the component loops to block 2103 to perform the next iteration, else the component continues at block 2107. In block 2107, the component invokes a method of the object to perform its simulation calculation. In one embodiment, the objects may be a classic object-oriented type objects with a simulation method, an initialize simulation method, and so on. The component then loops to block 2105 to select the next object.

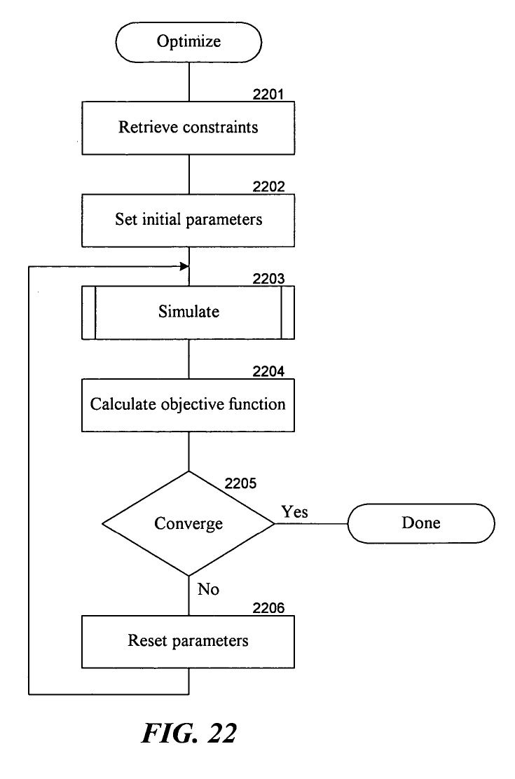

FIG. 22 is a flow diagram illustrating the optimize component in one embodiment. The optimize component sets initial parameters for the simulation and then performs the simulation. The component then calculates an objective function, resets the parameters based on the value of the objective function, and performs the simulation again. This process is repeated until the results of the objective function converge to an optimal solution. In block 2201, the component retrieves the user specified constraints for the optimization. In block 2202, the component sets the initial parameters within the constraints for the simulation. In block 2203, the component performs the simulation based on the current parameters. In block 2204, the component calculates the objective function based on the results of the simulation. In decision block 2205, if the results of the objective function converges on a solution, then the component completes, else the component continues at block 2206. In block 2206, the component resets the parameters based on the results of the objective function and then loops to block 2203 to perform the simulation again.

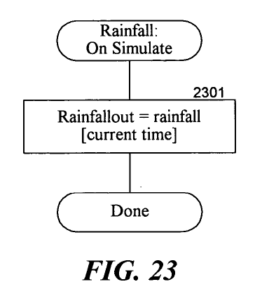

FIGS. 23-28 are flow diagrams illustrating calculations of example objects in one embodiment. FIG. 23 is a flow diagram illustrating the calculations performed by a rainfall object. The input to the simulation includes the rainfall data on a periodic basis. In block 2301, if the simulation interval is the same as a periodic basis of the rainfall, then at the component retrieves the rainfall amount for the current time and designates it as the output rainfall of the object, which serves as an inflow to the areas. Alternatively, if the simulation interval and the periodic basis for the rainfall are not the same, then the component adjusts the rainfall amounts to correspond to the interval. For example, if the periodic basis of the rainfall is hourly, but the simulation interval is daily, then at the component may need to aggregate the rainfall total for each day from the hourly amounts.

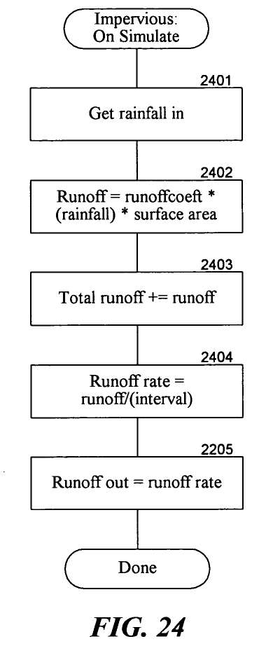

FIG. 24 is a flow diagram illustrating the calculations performed by an impervious object, such as a roof object. In block 2401, the component retrieves the rainfall in information for the interval provided by the rainfall object. The rainfall in information may be in total inches of rainfall for the interval. In block 2402, the component calculates the runoff by multiplying the runoff coefficient by the rainfall by the impervious surface area. In block 2403, the component adds the runoff to a running total of the runoff for the area. In block 2404, the component sets the runoff rate to the current runoff divided by the interval. In block 2405, the component sets the runoff out for this object to the runoff rate and then completes.

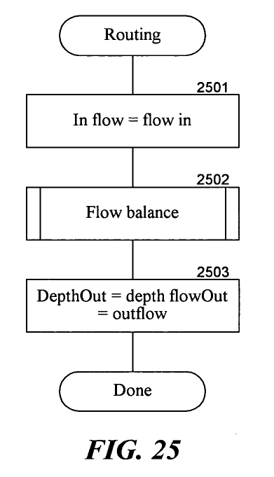

FIG. 25 is a flow diagram illustrating the calculations performed by a routing object, such as a channel. In block 2501, the component retrieves the flow in volume which may be the runoff out of several impervious areas. In block 2502, the component calculates the flow balance for the routing object. In block 2503, the component sets the output information for the object including the output depth and the output flow. The component then completes.

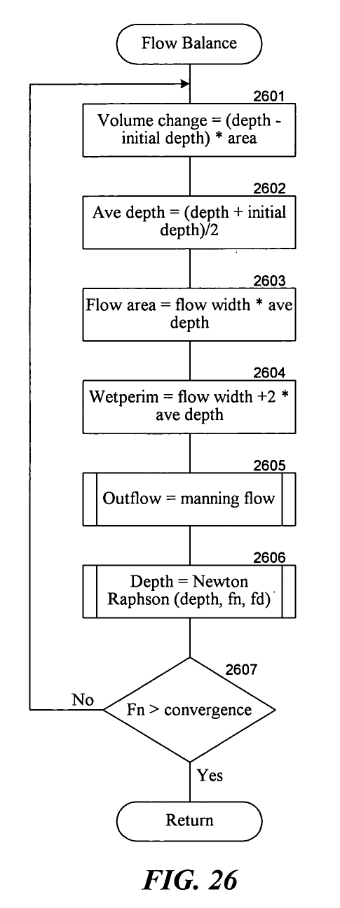

FIG. 26 is a flow diagram illustrating the calculations performed by the flow balance component of the routing object in one embodiment. The flow balance component balances to the input flow and output flow for the channel. The component loops until it converges on a solution for the flow. In block 2601, the component sets the volume change to the current depth minus the initial depth times the area. In block 2602, the component sets the average depth to the current depth plus the initial depth divided by two. In block 2603, the component sets the flow area to the flow width times the average depth of the channel. In block 2604, the component sets the wet perimeter area to the flow width plus two times the average depth. In block 2605, the component calculates the outflow based on the Manning flow. In block 2606, the component calculates the depths according to a Newton-Raphson approximation passing a function and its derivative. In decision block 2607, if the results of the approximation converges, then the component returns, else the component loops to block 2601.

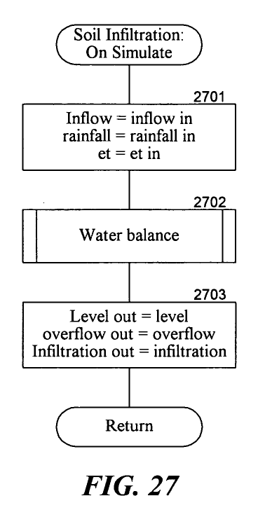

FIG. 27 is a flow diagram illustrating the processing of the calculations performed by the soil infiltration component in one embodiment. In block 2701, the component retrieves the input parameters of inflow, rainfall, and evapotranspiration. In block 2702, the component invokes the component to calculate the water balance. In block 2703, the component sets the output for the object as level, overflow, and infiltration.

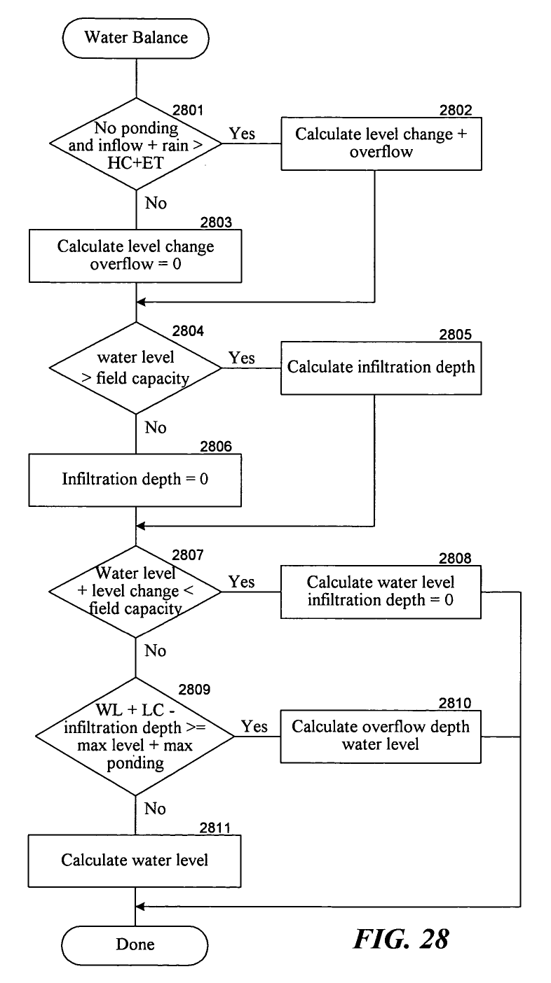

FIG. 28 is a flow diagram illustrating processing of the calculations performed by the water balance component of the soil infiltration object in one embodiment. In decision block 2801, if there is no ponding and the inflow plus the rainfall is greater then the hydraulic capacity plus the evapotranspiration, then the component continues at block 2802, else the component continues at block 2803. In block 2802, the component sets the change in level to the hydraulic capacity of the surface times the interval minus the evapotranspiration times the crop coefficient. The component also sets the overflow depth to the runoff in times the rise rate plus the rainfall minus the level change. In block 2803, the component sets the level change to the runoff in times the rise rate plus the rainfall minus the evapotranspiration times crop coefficient and sets the overflow depth to zero. In decision block 2804, if the water level is greater than the field capacity, then the component continues at block 2805, else the component continues at block 2806. In block 2805, the component calculates the infiltration depth as the minimum of the water level minus field capacity times release rate and the minimum of the hydraulic capacity of the surface or subsurface times the interval. In block 2806, the component sets infiltration depth to zero. In decision block 2807, if the water level plus the level change is less than the field capacity, then the component continues at block 2808, else the component continues at block 2809. In block 2808, the component sets the water level to the maximum of the water level plus the level change and the wilting point. The component also sets the infiltration depth to zero. In decision block 2809, if the water level plus the level change minus the infiltration depth is greater than or equal to the maximum level plus the maximum ponding depth, then the component continues at block 2810, else the component continues at block 2811. In block 2810, the component calculates the overflow depth as the overflow depth plus the water level plus the level change minus the infiltration depth minus the maximum level plus the maximum ponding depth. The component also sets the water level to the maximum level plus the maximum ponding. In block 2811, the component sets the water level to the water level plus level change minus the infiltration depth. The component then returns.

One skilled in the art will appreciate that although specific embodiments of the modeling system have been described herein for purposes of illustration, various modifications may be made without deviating from the spirit and scope of the invention. One skilled in the art will appreciate that the simulations can be performed based on a development design that may be specified with or without a graphical tool. For example, the design may be specified by a user using a text editor to specify the areas, attributes, and dependencies. One skilled in the art will also appreciate that modeling systems can be adapted to include the modeling of other flow components of water-related data, such as a sediment analysis and a fisheries analysis. To perform sediment analysis, the sediment build-up and wash-off of an impervious area can be modeled as described in Pitt, R., Stormwater Quality Management, CRC Press, New York, 2000; The sediment generation of a pervious area can be modeled as described in C. W. Richardson, G. R. Foster, and D. A. Wright, “Estimation of Erosion Index from Daily Rainfall Amounts,” Transactions of the ASAE 26(1): 153-157, 160 (1983) and C. T. Haan, B. J. Barfield, and J. C. Hayes, “Design Hydrology and Sedimentology for Small Catchments,” Academic Press, San Diego, Calif. (1994). The sediment transport of a pervious area can be modeled based on V. Vaneni, Sedimentation Engineering, ASCE Manual 54, ASCE, New York (1975). One skilled in the art will appreciate that the modeling system can accommodate any size of area under consideration (from regional watershed to a few acres in a housing development), a temporal resolution appropriate to the problem being addressed, best management practices algorithms that compute the retention processes under different loading (e.g., rainfall) conditions to provide more realistic estimates of efficacy, and uncertainty calculations based on the statistical distribution of parameters. Accordingly, the invention is not limited except by the appended claims.

1. A method in a computer system for modeling flow of water of a site having sources of water and areas of land uses, the method comprising:
providing objects representing areas of a land use, each object for calculating the outflow of water for that area based on an inflow of water and attributes of the object;
providing objects representing sources of water, each object for calculating the outflow of that source of water;
generating a graphical representation of flow of water dependencies of the areas and the sources of water, the dependencies indicating an outflow from an area or source of water to an inflow of an area, each area and water source having an associated object;
receiving attributes describing each area and each source of water of the site; and
performing a simulation of water flow by, for each of a plurality of time increments,
invoking the object associated with each source of water to calculate the outflow of that source of water for that time increment; and
invoking the object associated with each area in accordance with the dependencies to calculate the outflow of that area for that time increment.

2. The method of claim 1 wherein the areas include impervious and pervious areas.

3. The method of claim 1 wherein the generating of the graphical representation includes:
providing an icon representing each area and source of water; and
receiving from a user instructions on the placement and interconnection of the icons, the interconnections representing the dependencies.

4. The method of claim 1 wherein the attributes of an area include size of the area.

5. The method of claim 1 wherein the attributes of a source of water include periodic rainfall amounts.

6. The method of claim 1 wherein outflow includes run off.

7. The method of claim 1 wherein outflow includes evapotranspiration.

8. The method of claim 1 wherein outflow includes infiltration.

9. The method of claim 1 wherein outflow includes interflow.

10. The method of claim 1 wherein outflow includes groundwater flow.

11. The method of claim 1 including:
receiving constraints;
receiving an objective function; and
repeatedly performing the simulation varying parameters within the received constraints to optimize the objective function.

12. The method of claim 1 wherein an area represents multiple occurrences similar areas.

13. The method of claim 1 wherein multiple outflows can be combined into a single outflow.

14. The method of claim 1 wherein an outflow can be divided into multiple outflows.

15. The method of claim 1 wherein objects also calculate sediment amounts.

16. A method in a computer system for modeling flow of water of a site having areas of each land use and sources of water, the method comprising:
generating a graphical representation of the flow of water dependencies of areas and sources of water of the site, the dependencies indicating an outflow from an area or source of water to an inflow of an area;
receiving attributes describing each area and each source of water; and
performing a simulation of flow of water by, for each of a plurality of time increments,
calculating the outflow of each source of water for that time increment based on the attributes of the source of water; and
calculating the outflow of each area for that time increment based on the inflows and attributes of that area.

17. The method of claim 16 wherein the generating of the graphical representation includes:
providing an icon representing each area and water source; and
receiving from a user instructions on placement and interconnection of the icons, the interconnections representing the dependencies.

18. The method of claim 16 wherein the attributes of an area include size of the area.

19. The method of claim 16 wherein the attributes of a source of water include periodic rainfall amounts.

20. The method of claim 16 including repeatedly performing the simulation varying parameters based on user provided constraints to optimize an objective function.

21. The method of claim 16 wherein the areas are pervious or impervious.

22. The method of claim 16 wherein an impervious area is a road.

23. The method of claim 16 wherein an impervious area is a roof.

24. The method of claim 16 wherein the generating of the graphical representation includes providing an icon for each type of impervious area.

25. The method of claim 16 wherein the generating of the graphical representation includes providing an icon for each type of pervious area.

26. A method in a computer system for modeling flow of water of a site having areas of each land use and sources of water, the method comprising:
generating a graphical representation of the flow of water dependencies of areas and sources of water of the site, the dependencies indicating an outflow from an area or source of water to an inflow of an area;
receiving attributes describing each area and each source of water; and
performing a simulation of flow of water based on the attributes and dependencies of the areas and source of water.

27. The method of claim 26 wherein the graphical representation is generated by dragging and dropping icons representing areas of the site.

28. The method of claim 26 wherein the graphical representation is generated by dragging and dropping icons representing rainfall and evapotranspiration.

29. The method of claim 26 wherein the graphical representation is generated by connecting icons to indicate flow of water.
